(19) United States
(12) Patent Application Publication
(10) Pub. No.: US 2004/0023037 A1
(43) Pub. Date: Feb. 5, 2004

(54) Multilayer structure which includes a tie based on a polyolefin grafted by an acrylic monomer

(75) Inventors: Martin Baumert, Serquigny (FR); Romain Severac, Grabels (FR)

Correspondence Address: MILLEN, WHITE, ZELANO & BRANIGAN, P.C., 2200 CLARENDON BLVD., SUITE 1400, ARLINGTON, VA, 22201, US

(73) Assignee: ATOFINA, Puteaux (FR)

(21) Appl. No.: 10/439,332

(22) Filed: Sep. 17, 2003

(30) Foreign Application Priority Data
May 16, 2002 (FR) 02.06019

(51) Int. Cl. B32B 27/00

(52) U.S. Cl. 428/421; 428/480

(57) ABSTRACT

The present invention relates to a multilayer structure comprising:

a tie layer based on a graft polymer resulting from the polymerization of at least one alkyl (meth)acrylate in the presence of a polyolefin and directly attached to the latter; and

a layer of a polymer chosen from polyolefins, acrylic polymers and fluoropolymers.

The polymerization of the alkyl (meth)acrylate in the presence of the polyolefin may be carried out in an extruder in which the polyolefin is in the melt. A radical initiator, such as a peroxide, is also added.

The thickness of this structure may be of the order of 100 μm up to several mm or cm.

The present invention also relates to a structure comprising, in this order:

a layer of a polymer chosen from polyolefins, acrylic polymers and fluoropolymers;

a layer of the aforementioned tie; and

a layer of a polymer chosen from polyolefins, acrylic polymers and fluoropolymers;

the layers adhering to one another.

Preferred structures are those in which the layers on each side of the tie are different.

The present invention also relates to a structure comprising, in this order:

a layer of a polymer chosen from polyolefins, acrylic polymers and fluoropolymers;

a layer of the aforementioned tie;

a layer of a polymer chosen from polyolefins, acrylic polymers and fluoropolymers;

a layer of the aforementioned tie; and

a layer of a polymer chosen from polyolefins, acrylic polymers and fluoropolymers;

the layers adhering to one another.

Preferred structures are those in which the central layer is different from the outermost layers, these outermost layers being able to be identical or different.

The present invention also relates to devices for transferring or storing fluids, and more particularly to pipes, tanks, ducts, bottles and containers formed from the above structures.

The present invention relates to a multilayer structure which includes a tie based on a polyolefin grafted by an acrylic monomer. More specifically, the structure of the invention comprises a layer of the aforementioned tie and, directly attached to the latter, a layer of a polymer chosen from polyolefins, acrylic polymers and fluoropolymers. The thickness of this structure may be of the order of 100 μm up to several mm or cm.

For example, a structure comprising a tie layer and a layer of a fluropolymer is useful for covering a polyolefin substrate. All that is required is to inject the substrate in the melt onto the multilayer structure placed in the bottom of an injection-moulding mould, the fluoropolymer layer being placed against the wall of the mould.

The present invention also relates to a structure comprising, in this order, a layer of a polymer chosen from polyolefins, acrylic polymers and fluoropolymers, a layer of the aforementioned tie and a layer of a polymer chosen from polyolefins, acrylic polymers and fluoropolymers. For example, a structure comprising, in this order, a polyolefin layer, a layer of the tie and a layer of a fluoropolymer (for example PVDF) may be a pipe whose inner layer is made of PVDF. The PVDF layer allows the polyolefin pipe to be resistant and a barrier to many fluids. This structure may also be a tank made of a polyolefin having an inner PVDF layer and is useful as a petrol tank for motor vehicles.

The invention also relates to structures comprising a central layer either of a polyolefin or of an acrylic polymer or of a fluoropolymer and, on each side, a tie layer and another layer of a polymer chosen from polyolefins, acrylic polymers and fluoropolymers.

Patent application WO 02/20644 discloses structures comprising, in this order, a polypropylene layer, a tie consisting of a polypropylene backbone on which PMMA grafts are attached and a PVDF layer. To manufacture the tie, maleic anhydride is grafted onto a polypropylene backbone and then this backbone carrying the maleic anhydride is made to react with a copolymer of MMA (methyl methacrylate) and HEMA (hydroxyethyl methacrylate). The reaction between maleic anhydride and HEMA allows the PMMA graft to be fixed. This reaction is not easy to carry out and the MMA-HEMA copolymer is also difficult to manufacture.

Patent application JP 08336937 A, published on Dec. 24, 1996, discloses structures similar to those of the above prior art, but the tie is a graft copolymer obtained by solution polymerization of a mixture of MMA, acrylonitrile and styrene in the presence of an elastomer chosen from hydrogenated SBs (copolymers having polystyrene blocks and polybutadiene blocks), hydrogenated polybutadienes and EPRs (short for Ethylene-Propylene Rubbers). These graft polymers have nothing to do with the tie consisting of a polypropylene backbone on which PMMA grafts are attached and which is described in the above prior art WO 02/20644. The tie is much simpler to manufacture than that of the above prior art, but these structures have insufficient properties, in particular in the presence of petrol. This is because in a tank having, respectively, a polyolefin outer layer, a tie layer and a PVDF inner layer, and although PVDF is a very good barrier, very small amounts of petrol do, however, pass through the PVDF layer and enter the tie.

A tie has now been found for making a polyolefin layer adhere to a PVDF layer, the said tie being a graft polymer obtained by polymerization of MMA in the presence of preferably VLDPE (short for Very Low Density Polyethylene) or an ethylene-alkyl (meth)acrylate copolymer. This polymerization may take place in an extruder with or without any solvent, but advantageously without solvent.

The prior art has already disclosed very similar products, but never in multilayer structures.

EP 33 220 discloses graft polymers obtained by polymerization in an extruder of MMA in the presence of a polymer chosen from EPRs, blends of EPR with an LDPE (short for Low Density Polyethylene), EVAs (ethylenes vinyl acetate copolymer) and EPR/EVA blends. These graft polymers are used as impact modifiers in PVC.

U.S. Pat. No. 4,476,283 discloses graft polymers obtained by polymerization in an extruder of MMA, styrene or acrylonitrile in the presence of an EPDM (ethylene-propylene-diene copolymer)/EPR blend. These graft polymers are used as a blend with EPDMs, SBRs (short for Styrene-Butadiene Rubbers) or NBRs (short for Nitrile-Butadiene Rubbers).

The present invention relates to a multilayer structure comprising:

a tie layer based on a graft polymer resulting from the polymerization of at least one alkyl (meth)acrylate in the presence of a polyolefin and directly attached to the latter; and

a layer of a polymer chosen from polyolefins, acrylic polymers and fluoropolymers.

The polymerization of the alkyl (meth)acrylate in the presence of the polyolefin may be carried out in an extruder in which the polyolefin is in the melt. A radical initiator, such as a peroxide, is also added.

The thickness of this structure may be of the order of 100 μm up to several mm or cm.

The present invention also relates to a structure comprising, in this order:

a layer of a polymer chosen from polyolefins, acrylic polymers and fluoropolymers;

a layer of the aforementioned tie; and

a layer of a polymer chosen from polyolefins, acrylic polymers and fluoropolymers;

the layers adhering to one another.

Preferred structures are those in which the layers on each side of the tie are different.

The present invention also relates to a structure comprising, in this order:

a layer of a polymer chosen from polyolefins, acrylic polymers and fluoropolymers;

a layer of the aforementioned tie;

a layer of a polymer chosen from polyolefins, acrylic polymers and fluoropolymers;

a layer of the aforementioned tie; and

a layer of a polymer chosen from polyolefins, acrylic polymers and fluoropolymers;

the layers adhering to one another.

Preferred structures are those in which the central layer is different from the outermost layers, these outermost layers being able to be identical or different.

The present invention also relates to devices for transferring or storing fluids, and more particularly to pipes, tanks, ducts, bottles and containers formed from the above structures.

With regard to the tie and firstly the alkyl (meth)acrylates. Alkyl (meth)acrylates are described in KIRK-OTHMER, Encyclopedia of Chemical Technology, 4^{th} edition in Vol. 1 pages 292-293 and in Vol. 16 pages 475-478. The alkyl (meth)acrylate is advantageously methyl methacrylate. According to another advantageous form, a mixture comprising at least 50% by weight of methyl methacrylate is chosen, the other monomers being chosen from monomers able to be grafted in the presence of methyl methacrylate and of the polyolefin. These other monomers may be another alkyl acrylate, such as methyl acrylate or ethyl acrylate, acrylonitrile, a vinylaromatic monomer, such as styrene, or a mixture of at least two of these monomers. Preferably, the proportion of methyl methacrylate is from 90 to 100% per 0 to 10% of the other monomers, respectively.

With regard to the tie and now the polyolefin, these are thus a homopolymer or a copolymer of alpha-olefins or diolefins, such as, for example, ethylene, propylene, 1-butene, 1-octene and butadiene. By way of examples, mention may be made of:

ethylene homopolymers and copolymers, particularly LDPE, HDPE, LLDPE (linear low density polyethylene), LDPE (low density polyethylene), VLDPE (very low density polyethylene) and metallocene polyethylene;

propylene homopolymers and copolymers;

ethylene/alpha-olefin copolymers, such as ethylene/propylene copolymers, EPRs (short for ethylene-propylene rubbers) and ethylene/propylene/diene copolymers (EPDM);

copolymers of ethylene with at least one product chosen from salts or esters of unsaturated carboxylic acids such as an alkyl (meth)acrylate (for example methyl acrylate), or vinyl esters of saturated carboxylic acids such as vinyl acetate, the proportion of comonomer possibly being as much as 40% by weight.

Advantageously, the polyolefin is chosen from VLDPE and ethylene-alkyl (meth)acrylate copolymers.

With regard to the VLDPE, the density may be between 0.865 and 0.920 and the MFI (short for Melt Flow Index) between 1 and 100 and preferably between 1 and 25 (in g/10 min at 190° C. under a load of 2.16 kg). This is, for example, an ethylene-octene or ethylene-butene copolymer. A blend of several VLDPEs may be used.

With regard to the ethylene-alkyl (meth)acrylate copolymers, the alkyls may have up to 24 carbon atoms. Examples of alkyl acrylates or methacrylates are especially methyl methacrylate, ethyl acrylate, n-butyl acrylate, isobutyl acrylate and 2-ethylhexyl acrylate. The MFI (Melt Flow Index) of these copolymers is advantageously between 0.3 and 100 g/10 min (190° C./2.16 kg). Advantageously, the (meth)acrylate content is between 18 and 40% and preferably between 22 and 28% by weight of (A). These copolymers may be manufactured by radical polymerization in a tube reactor or in an autoclave at pressures of between 1,000 and 2,500 bar. A blend of several of these copolymers may be used.

With regard to the tie and to its preparation, all that is required is to bring the monomer into contact with the polyolefin in the presence of an initiator for a time long enough to cause the grafting. Any process may be used, for example the polyolefin may be in a solvent or in latex form. However, it is much simpler to bring the alkyl (meth)acrylate into contact with the polyolefin in the melt in any thermoplastic blending or mixing device. It is advantageous to use an extruder in which granules of the polyolefin are introduced into the first zone and then, a few zones downstream, the alkyl (meth)acrylate and the radical initiator are introduced. The alkyl (meth)acrylate and the radical initiator may also be introduced separately. The graft polymer is cooled and recovered in the form of granules to be used thereafter or for subsequent use. Depending on the nature of the alkyl (meth)acrylate which is grafted, its boiling point may be much lower than the melting point of the polyolefin or the temperature at which the polyolefin is maintained in the extruder. Thus, it is recommended that the screw (or screws) have reverse pitches in certain zones in order to cause plugs of material and to obtain a sealed profile thus keeping the alkyl (meth)acrylate in the extruder in contact with the polyolefin. This principle is known per se and has already been disclosed in the prior art, such as U.S. Pat. No. 4,476,283.

With regard to the proportions of alkyl (meth)acrylate and polyolefin which are brought into contact with one another, the ratio of the amount of alkyl (meth)acrylate by weight to the amount of polyolefin by weight (or the ratio of the flow rates if a continuous operation is involved) may be between 0.1 and 10 and advantageously between 0.5 and 2.

The temperature of the extruder in the zones may be between 110 and 200° C. and advantageously between 120 and 150° C.

The proportion of initiator may be between 0.005 to 10% by weight of the amount of alkyl (meth)acrylate and optionally of the other monomers to be grafted. Preferably, this proportion is between 0.5 and 3%. The initiator may be of any type provided that it causes grafting of the alkyl (meth)acrylate. This is, for example, one of the initiators used in radical polymerizations. Advantageously, peroxides are used.

The proportion of alkyl (meth)acrylate and of the other optional graft monomers with respect to the combination of the alkyl (meth)acrylate, the other optional monomers and the polyolefin onto which the grafting has taken place is advantageously between 20 and 80% by weight. Preferably, the proportion is between 40 and 70% by weight.

The tie may also include, in addition to the graft polymer, at least one product chosen from fluoropolymers (these will be defined later in the text), polyolefins, functionalized polyolefins, acrylic polymers (PMMA), acrylic impact modifiers of the core-shell type or a blend of these products. The functionalized polyolefin may be an alpha-olefin polymer having reactive units (the functional groups); such reactive units are acid, anhydride or epoxy functional groups. By way of example, mention may be made of the above polyolefins which are grafted or are copolymerized or terpolymerized by unsaturated epoxides such as glycidyl (meth)acrylate, or by carboxylic acids or the corresponding salts or esters, such as (meth)acrylic acid (this possibly being completely or partially neutralized by metals such as Zn, etc.) or else by carboxylic acid anhydrides such as maleic anhydride. A functionalized polyolefin is, for example, a PE/EPR blend, the weight ratio of which may vary between wide limits, for example between 40/60 and 90/10, the said blend being cografted with an anhydride, especially maleic anhydride, with a degree of grafting, for example, of 0.01 to 5% by weight.

The functionalized polyolefin may be chosen from the following (co)polymers, grafted with maleic anhydride or glycidyl methacrylate, in which the degree of grafting is, for example, from 0.01 to 5% by weight:

PE, PP, copolymers of ethylene with propylene, butene, hexene or octene and containing, for example, from 35 to 80% by weight of ethylene;

ethylene/alpha-olefin copolymers such as ethylene/propylene copolymers, EPRs (short for ethylene-propylene rubbers) and ethylene/propylene/diene copolymers (EPDM);

styrene/ethylene-butylene/styrene block copolymers (SEBS), styrene/butadiene/styrene block copolymers (SBS), styrene/isoprene/styrene block copolymers (SIS), styrene/ethylene-propylene/styrene block copolymers (SEPS);

ethylene-vinyl acetate copolymers (EVA), containing up to 40% by weight of vinyl acetate;

ethylene-alkyl (meth)acrylate copolymers, containing up to 40% by weight of alkyl (meth)acrylate;

ethylene-vinyl acetate (EVA)-alkyl (meth)acrylate copolymers, containing up to 40% by weight of comonomers.

The functionalized polyolefin may also be chosen from ethylene/propylene copolymers containing predominantly propylene, these being grafted by maleic anhydride and then condensed with monoaminated polyamide (or a polyamide oligomer) (products described in EP-A-0 342 066).

The functionalized polyolefin may also be a copolymer or terpolymer of at least the following units: (1) ethylene, (2) an alkyl (meth)acrylate or a vinyl ester of a saturated carboxylic acid and (3) an anhydride such as maleic anhydride or a (meth)acrylic acid or an epoxy such as glycidyl (meth)acrylate. By way of examples of functionalized polyolefins of this latter type, mention may be made of the following copolymers, in which the ethylene preferably represents at least 60% by weight and in which the termonomer (the functional group) represents, for example, from 0.1 to 10% by weight of the copolymer:

ethylene/alkyl (meth)acrylate/(meth)acrylic acid or maleic anhydride or glycidyl methacrylate copolymers;

ethylene/vinyl acetate/maleic anhydride or glycidyl methacrylate copolymers;

ethylene/vinyl acetate or alkyl (meth)acrylate/(meth)acrylic acid or maleic anhydride or glycidyl methacrylate copolymers.

In the above copolymers, the (meth)acrylic acid may be salified with Zn or Li.

Advantageously, the proportion of polymer grafted by the alkyl (meth)acrylate represents at least 30% by weight of the tie.

With regard to the layer of polymer attached directly to the tie layer and firstly polyolefins, these products having been defined above.

As examples of acrylic polymers, mention may be made of alkyl (meth)acrylate homopolymers. Alkyl (meth)acrylates are described in KIRK-OTHMER, Encyclopedia of Chemical Technology, 4^{th} Edition in Vol. 1 pages 292-293 and in Vol. 16 pages 475-478. Mention may also be made of copolymers of at least two of these (meth)acrylates and of copolymers of at least one (meth)acrylate with at least one monomer chosen from acrylonitrile, butadiene, styrene and isoprene, provided that the proportion of (meth)acrylate is at least 50 mol %. The invention is particularly useful in the case of PMMA. Advantageously, PMMA comprises 90 to 100% by weight of MMA per 10 to 0% of another acrylate, respectively. This other acrylate may be ethyl acrylate. These acrylic polymers either consist of monomers and optionally of the co-monomers mentioned above and do not contain an impact modifier or they also contain an acrylic impact modifier. The acrylic impact modifiers are, for example, random or block copolymers of at least one monomer chosen from styrene, butadiene and isoprene, and of at least one monomer chosen from acrylonitrile and alkyl (meth)acrylates; they may be of the core-shell type. These acrylic impact modifiers may be blended with the acrylic polymer once it has been prepared or may be introduced during its polymerization or prepared simultaneously during its polymerization. The MFI (Melt Flow Index) of (A) may be between 2 and 15 g/10 min measured at 230° C. under a load of 3.8 kg.

The amount of acrylic impact modifier may, for example, be from 0 to 30 parts per 100 to 70 parts of the acrylic polymer and advantageously from 5 to 20 parts per 95 to 80 parts of the acrylic polymer.

It would not be outside the scope of the invention if the acrylic polymer were to be a blend of two or more of the above polymers.

As examples of fluoropolymers, mention may most particularly be made of:

PVDFs, vinylidene fluoride (VF2) homopolymers and vinylidene fluororide (VF2) copolymers preferably containing at least 50% by weight of VF2 and at least one other fluoromonomer, such as chlorotrifluoroethylene (CTFE), hexafluoropropylene (HFP), trifluoroethylene (VF3) and tetrafluoroethylene (TFE);

trifluoroethylene (VF3) homopolymers and copolymers; and

copolymers, especially terpolymers, combining residues of chlorotrifluoroethylene (CTFE), tetrafluoroethylene (TFE), hexafluoropropylene (HFP) and/or ethylene units and, optionally, of PF2 and/or VF3 units.

Among these fluoropolymers, PVDF is advantageously used.

Particularly useful structures comprise, in this order, a polyolefin layer, a tie layer and a PVDF layer. They may also include an additional layer between the polyolefin layer and the tie layer; this is, for example, a layer of the same structure but one which has been reground in order to recycle non-conforming structures.

They may also be in the form of pipes whose inner layer is made of PVDF, the outside diameter which is between 8 and 50 mm and the thickness of which is between 0.8 and 10 mm. The PVDF layer and the tie layer may represent from 1 to 30% of the total thickness. Advantageously, the polyolefin in these pipes is polypropylene.

According to another embodiment, they may be in the form of a tank or of a container, the outer layer of which is made of polyolefin, the volume of which may be between 1 and 100 litres and the thickness of which may be between 1 and 25 mm. The PVDF layer and the tie layer may represent from 1 to 30% of the total thickness. Advantageously, in these containers or tanks, the polyolefin is HDPE.

According to another embodiment, they may be in the form of a tank or container, the outer layer and the inner layer of which are made of polyolefin and the central layer of which is made of PVDF, the volume may be between 1 and 100 litres and the thickness may be between 1 and 35 mm. The PVDF layer and the tie layers may represent from 1 to 30% of the total thickness. Advantageously, in these containers or tanks, the polyolefin is HDPE.

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

In the foregoing and in the following examples, all temperatures are set forth uncorrected in degrees Celsius and, all parts and percentages are by weight, unless otherwise indicated.

The following products were used:

LUPEROX 26®: (tert-butyl-2-ethylperhexanoate, MW=216.3 g/mol, t_{1/2} (1 min)=130.0° C.);

ENGAGE® 8200: VLDPE (ethylene-octene copolymer) having the following characteristics:

| | Mooney | | | | | | |
|---|---|---|---|---|---|---|---|
| | Viscos- | | | | | | |
| | ity | | | | | | |
| Den- | (ML | | Elonga- | | | | |
| sity | 1 + at | MFI | tion at | | | | |
| (g/ | 121° | (Dg/ | break | Tₘ | T_{g} | \overline{Mₙ} | \overline{M_{w}} |
| cm³) | C.) | min⁻¹) | (%) | (DSC) | (DSC) | (g/mol) | (g/mol) |
| 0.870 | 8 | 5.0 | >1000% | 64.9 | −59.4 | 33 000 | 75 500 |
| | | | | ° C. | ° C. | | |

SUPERFLEX 2500-20: VF2-HFP copolymer, MVI (Melt Volume Index)=10 cm³/10 min at 230° C./5 kg);

KYNAR 750 ®: PVDF homopolymer having an MVI of 10 cm³/10 min at 230° C./5 kg.

HDPE 2040 ML 55: High-density polyethylene having an MFI of 19.6 g/10 min at 190° C./2.16 kg.

OROGLAS® V 825T: PMMA not containing an acrylic impact modifier characterized by an MFI=2.8 cm³/10 min (230° C./3.8 kg) and a Charpy impact strength at +23° C. of 20 kJ/m².

OROGLAS®HF 17: PMMA containing an acrylic impact modifier characterized by an MFI=10.3 cm³/10 min (230° C./3.8 kg) and a Charpy impact strength at +23° C. of 45 kJ/m²; and

PP EP2C30F (also called RP210M): a polypropylene sold by BASELL having the following characteristics: MFI of 6 dg/min (230° C./2.16 kg), density of 0.9 g/cm³ and a flexural modulus of 850 MPa.

Methyl methacrylate (MMA) was grafted onto a VLDPE (ENGAGE® 8200) by means of an extruder. The extruder used for these trials was a BC 21 (corotating twin-screw CLEXTRAL® extruder with 25 mm diameter screws, 21 mm centre-to-centre spacing and screw length/diameter of 8 to 36). It consisted of nine heated barrel segments with an individual power of 1 kW. The BC 21 was provided with an automatic control system, with the possibility of recording and displaying the working parameters. The screw elements of 25 or 50 mm in length could be juxtaposed on splined shafts. The profile was as indicated in the following figure:

[image]

A specific process as regards sealing had to be used: the polymethyl methacrylate was processed at extrusion temperatures above at least 170° C. Since the boiling point of MMA is 100° C., one of the main difficulties with this process was to achieve a sealed profile. This was able to be obtained thanks to plugs of material created by elements of reverse pitch in sections 3 and 7. In this zone, the MMA could reach its liquid-vapour equilibrium at its saturated vapour pressure and remain liquid in a monomer-saturated atmosphere. Kneading elements were added, in section 3, to facilitate the melting of VLDPE, and in sections 5, 6 and 7 to improve the diffusion through this viscous medium that the PE/PMMA/monomer compound constitutes. The venting zone in section 7 allows the residual MMA to be removed. Conveying elements of large screw pitch were placed in this zone in order to optimize the venting. The reactive zone was therefore between sections 4 and 7 of the extruder.

Section 1 was cooled to 15° C. in order to improve the extruder feed and prevent the VLDPE from becoming tacky before its entry into the barrel. Sections 2 and 3 were heated to 135° C. so as to take the ENGAGE® 8200 above its melting point. Sections 4 to 7 were the reactive zones in our process. The temperatures were therefore adapted to the flow rates and initiators used (LUPEROX 26, which has a half-life of 1 minute at 130° C.; this zone was heated to 150° C.). Sections 8 to 10, having to facilitate the extrusion of the PMMA formed, were thus heated to 200° C.

The degrees of conversion were around 80% (0.6-9.18%, with a constant temperature of 150 to 160° C.). A series of trials (Table 1) was carried out and characterized by DSC, DMA, IR, a tensile measurement and a creep measurement.

TABLE 1
trials carried out with LUPEROX 26

| | % | | MMA | % con- | | |
|---|---|---|---|---|---|---|
| | initiator | PE flow | solution | version | | % |
| | in | rate | flow | to | % | residual |
| Examples | MMA | (kg/h) | rate (kg/h) | MMA* | PMMA* | MMA |
| 1 | 1.98 | 1 | 1 | 69 | 40 | 2.82 |
| 2 | 1.98 | 1 | 1.5 | 75 | 53 | 3.40 |
| 3 | 1.98 | 1 | 2 | 73 | 59 | 3.64 |
| 4 | 5 | 1 | 1 | 80 | 44 | 1.48 |
| 5 | 1.3 | 1 | 1 | <70 | <40 | 2.31 |

*determined from the flow rate at the die.

Characterization:

Tensile measurements:

To carry out tensile tests, 2×5×100 mm test pieces were produced by injection moulding (injection-moulding press with a barrel temperature of 225° C. and a mould temperature of 100° C.).

Creep:

The same test pieces (2×5×100 mm) used for the tensile measurements were used to carry out creep tests. The tests were carried out at 100° C. with a weight standardized according to their cross section at 1 bar (0.1 N/mm²) and the strain measurements were made after a quarter of an hour.

DMA:

The DMA measurements were carried out on 4×10×100 mm test pieces injection-moulded in the injection-moulding press (barrel temperature: 225° C., mould temperature: 100° C.). The stressing method used was 3-point bending, the specimen being fixed at its ends, and a bending strain was imposed on it at the centre of the specimen at a frequency of 1 rad/s from −100° C. to 130° C.

To compare the PMMA/VLDPE specimens, the comparative examples, ENGAGE®8200 (Example 6) and OROGLASS® V 825 T (Example 7) were also tested.

TABLE 2
Results of the tensile tests

| | | | Elongation | |
|---|---|---|---|---|
| | σ_{break} | ξ_{break} | at | Strain^{a)} |
| Examples | (MPa) | (mm) | break (%) | (%) |
| 1 | 11.87 ± 0.22 | 58.58 ± 0.85 | 130 ± 1 | −1.1 |
| 2 | 20.25 ± 0.58 | 2.26 ± 0.10 | 5.0 ± 0.2 | −5.3 |
| 3 | 15.437 ± 0.75 | 9.7 ± 1.4 | 22 ± 3 | −1.7 |
| 4 | 5.67 ± 0.14 | 7.45 ± 0.49 | 17 ± 1 | −4.4 |
| 5 | 13.00 ± 0.71 | 219.3 ± 7.4 | 487 ± 16 | +10.9 |
| 6 | 7.259 | 473.893 | >1050 | +∞ |
| ENGAGE 8200 | | | | |
| 7 | 70* | — | 6* | +0.9 |
| OROGLASS ® | | | | |
| V 825 | | | | |

^{a)}Creep at 100° C., 1 bar/15 min.

The VLDPE had an elongation so high that the apparatus was unable to measure it, but did not have a high tensile strength. In contrast, the PMMA had a high tensile strength, but the elongation was very low. The tests show an intermediate behaviour between these two bases, which, according to their composition, approach more one than the other. Trials 1 and 5 seem to have a VLDPE matrix given their high % elongation at break. The others seems to have MMA matrix, given their weakness.

DSC

The specimens tested in DSC had been put beforehand in an oven in order to remove as much of the residual MMA as possible. The determination of the glass transition temperature of ENGAGE® 8200 (Example 6) posed a few problems as it was so low.

TABLE 3
DSC Results

| | | | Energy of | | | |
|---|---|---|---|---|---|---|
| | LLDPE | LLDPE | melting | PMMA | % | % |
| Trial | Tₘ | T_{g} | (J/g) | T_{g} | PMMA* | PMMA** |
| 1 | 61.4 | −54.4 | 10.23 | 110.8 | 44 | 40 |
| 2 | 61.7 | −55.7 | 7.560 | 109.7 | 59 | 53 |
| 3 | 60.6 | −56.6 | 6.059 | 107.1 | 67 | 59 |
| 4 | 61.3 | −48.7 | 9.368 | 102.2 | 49 | 44 |
| 5 | 61.1 | −53.3 | 11.79 | 115.4 | 35 | <40 |
| 6 | 64.9 | −59.4 | 18.31 | — | 0 | 0 |
| 7 | — | — | — | 108*** | 100 | 100 |

*determined from the energy of melting, considering that the crystalline part remains constant despite the grafting;
**determined from the flow rates at the die;
**Vicat temperature (50° C./h, 50 N).

DMA Measurement

Since ENGAGE® 8200 is a low-viscocity polyolefin, it was impossible to apply it above 50° C.

Measurements of the modulus E′ show that this increases with the % of PMMA material having an almost constant modulus E′ for PMMA contents above 55%.

[image]

The measurements of the tanδ of the specimens show a slight reduction in the glass transition temperature of the LLDPE with the PMMA content.

[image]

### EXEMPLE 8

Bonding of the Tie of Example 2 to HDPE (2040ML55F)

“Wafers” 0.2 mm in thickness were firstly produced in a DARRAGON® press at 220° C. with the HDPE (2040 ML 55F) and the tie (Example 2) in the following manner:

2 minutes of preheating;

pressing for 2 minutes at 50 bar; and

cooling for 1 minute at 50 bar.

A complex was then produced by superimposing the 2040 ML 55F HDPE wafer on that of the tie. This complex was then held for 2 minutes in a press at 220° C. and 50 bar.

It was impossible to initiate debonding from the 2040 ML 55F HDPE.

### EXEMPLE 9

Bonding of the Tie of Example 2 to PP (MONTELL EP2C30F)

“Wafers” 0.2 mm in thickness were firstly produced in a DARRAGON® press at 220° C. with the MONTELL EP2C30F and the tie (Example 2) in the following manner:

2 minutes of preheating;

pressing for 2 minutes at 50 bar; and

cooling for 1 minute at 50 bar.

A complex was then produced by superimposing the EP2C30F wafer on that of the tie. This complex was then held for 2 minutes in a press at 280° C. and 50 bar.

It was impossible to initiate debonding from the MONTELL EP2C30F PP.

### EXEMPLE 10

Bonding of the Tie of Example 2 to ENGAGE 8200.

“Wafers” 0.2 mm in thickness were firstly produced in a DARRAGON® press at 220° C. with the ENGAGE 8200 and the tie (Example 2) in the following manner:

2 minutes of preheating;

pressing for 1 minute at 50 bar; and

cooling for 1 minute at 50 bar.

A complex was then produced by superimposing the ENGAGE 8200 wafer on that of the tie. This complex was then held for 1 minute in a press at 220° C. and 50 bar.

It was impossible to initiate debonding from the ENGAGE 8200.

### EXEMPLE 11

Bonding of the Tie of Example 2 to PVDF (KYNAR 720)

“Wafers” 0.2 mm in thickness were firstly produced in a DARRAGON® press at 220° C. with the KYNAR 720 and the tie (Example 2) in the following manner:

2 minutes of preheating;

pressing for 1 minute at 50 bar; and

cooling for 1 minute at 50 bar.

A complex was then produced by superimposing the KYNAR 720 wafer on that of the tie. This complex was then held for 1 minute in a press at 220° C. and 50 bar.

It was possible to initiate debonding from the KYNAR 720.

### EXAMPLE 12

Bonding of the Tie of Example 2 to a PVDF Copolymer (KYNARFLEX 2500-20).

“Wafers” 0.2 mm in thickness were firstly produced in a DARRAGON® press at 220° C. with the KYNAR 2500-20 and the tie (Example 2) in the following manner:

2 minutes of preheating;

pressing for 1 minute at 50 bar; and

cooling for 1 minute at 50 bar.

A complex was then produced by superimposing the PVDF copolymer wafer on that of the tie. This complex was then held for 1 minute in a press at 220° C. and 50 bar.

It was impossible to initiate debonding from the PVDF.

### EXAMPLE 13

Bonding of Example 2 to PMMA (HFI7).

“Wafers” 0.2 mm in thickness were firstly produced in a DARRAGON press at 220° C. with the PMMA (HF17) and the tie (Example 2) in the following manner:

2 minutes of preheating;

pressing for 1 minute at 50 bar; and

cooling for 1 minute at 50 bar.

A complex was then produced by superimposing the PMMA (HFI7) wafer on that of the tie. This complex was then held for 1 minute in a press at 220° C. and 50 bar.

It was impossible to initiate debonding from the PVDF.

### EXEMPLE 14

Bonding of Example 5 to HDPE (2040ML55F)

“Wafers” 0.2 mm in thickness were firstly produced in a DARRAGON press at 220° C. with the 2040 ML 55F HDPE and the tie (Example 5) in the following manner:

2 minutes of preheating;

pressing for 2 minutes at 50 bar; and

cooling for 1 minute at 50 bar.

A complex was then produced by superimposing the 2040 ML 55F HDPE wafer on that of the tie. This complex was then held for 2 minutes in a press at 220° C. and 50 bar.

It was possible to initiate debonding from the 2040 ML 55F HDPE. However, there was adhesion.

In general, the thickness of the tie layers is sufficient to bond the layers attached thereto and can vary depending on the structure and the composition of the contiguous layers. For additional details, reference is made to patent documents and the literature. A general range of thicknesses can for example, be from 10 microns to 1 mm.

The preceding examples can be repeated with similar success by substituting the generically or specifically described reactants and/or operating conditions of this invention for those used in the preceding examples.

The entire disclosures of all applications, patents and publications, cited herein and of corresponding French application No. 02.06019, filed May 16, 2002 is incorporated by reference herein.

From the foregoing description, one skilled in the art can easily ascertain the essential characteristics of this invention and, without departing from the spirit and scope thereof, can make various changes and modifications of the invention to adapt it to various usages and conditions.

1. Multilayer structure comprising:
a tie layer based on a graft polymer resulting from the polymerization of at least one alkyl (meth)acrylate in the presence of a polyolefin and directly attached to the latter; and
a layer of a polymer chosen from polyolefins, acrylic polymers and fluoropolymers.

2. Structure according to claim 1, comprising, in this order:
a layer of a polymer chosen from polyolefins, acrylic polymers and fluoropolymers;
a layer of the tie according to claim 1; and
a layer of a polymer chosen from polyolefins, acrylic polymers and fluoropolymers;
the layers adhering to one another.

3. Structure according to claim 1, comprising, in this order:
a layer of a polymer chosen from polyolefins, acrylic polymers and fluoropolymers;
a layer of the tie according to claim 1;
a layer of a polymer chosen from polyolefins, acrylic polymers and fluoropolymers;
a layer of the tie according to claim 1; and
a layer of a polymer chosen from polyolefins, acrylic polymers and fluoropolymers;
the layers adhering to one another.

4. Structure according to any one of claims 1 to 3, in which the alkyl (meth)acrylate that is grafted onto the polyolefin in order to make the tie is a monomer mixture comprising at least 50% by weight of methyl methacrylate, the other monomers being chosen from monomers able to be grafted in the presence of methyl methacrylate and of the polyolefin.

5. Structure according to claim 4, in which the proportion of methyl methacrylate by weight is from 90 to 100% per 0 to 10% of the other monomers, respectively.

6. Structure according to any one of the preceding claims, in which the polyolefin onto which the alkyl (meth)acrylate is grafted in order to make the tie is chosen from VLDPE and ethylene-alkyl (meth)acrylate copolymers.

7. Structure according to claim 7, in which the polyolefin is a VLDPE, the density of which may be between 0.865 et 0.920 and the MFI (short for Melt Flow Index) of which may be between 1 and 100 (in g/10 min at 190° C. under a load of 2.16 kg).

8. Structure according to any one of the preceding claims, in which the tie is such that the proportion of alkyl (meth)acrylate and of the other optional graft monomers with respect to the combination of the alkyl (meth)acrylate, the other optional monomers and the polyolefin onto which the grafting has taken place is between 20 and 80% by weight.

9. Structure according to claim 8, in which this proportion is between 40 and 70% by weight.

10. Structure according to any one of the preceding claims, in which the tie may also include, in addition to the graft polymer, at least one product chosen from fluoropolymers, polyolefins, functionalized polyolefins, acrylic polymers (PMMA), acrylic impact modifiers of the core-shell type or a blend of these products.

11. Devices for transferring or storing fluids, and more particularly pipes, tanks, ducts, bottles and containers formed from structures according to any one of the preceding claims.
